(19) United States
(12) Patent Application Publication
(10) Pub. No.: US 2013/0339139 A1
(43) Pub. Date: Dec. 19, 2013

(54) SYSTEM AND METHOD FOR NONSTANDARD CREATIVE CONTENT AUCTIONING

(71) Applicant: HIGH IMPACT MEDIA LLC, Venice, CA (US)

(72) Inventors: Chip Meyers, Rancho Palos Verdes, CA (US); Stefan Kosel, Miami, FL (US)

(73) Assignee: HIGH IMPACT MEDIA LLC, Venice, CA (US)

(21) Appl. No.: 13/896,830

(22) Filed: May 17, 2013

Related U.S. Application Data
(63) Continuation-in-part of application No. 13/352,815, filed on Jan. 18, 2012.

(51) Int. Cl. G06Q 30/02

(52) U.S. Cl. CPC G06Q 30/0275
USPC 705/14.49; 705/14.71

(57) ABSTRACT

The present design includes a method and apparatus for programmatically providing graphic content to a user device. The method includes evaluating a target display and if the target display is configured to receive content, altering code on the target web site, storing target display information, providing target display information, including information about at least one nonstandard region, to at least one bidder, facilitating an auction of the at least one nonstandard region to the at least one bidder, and establishing a winning bidder and displaying graphical content associated with the winning bidder in the one nonstandard region on the target display on the user device. These functions may be provided using a server arrangement.

The present application is a continuation-in-part of U.S. patent application Ser. No. 13/352,815, entitled “System and Method for Intelligently Sizing Content for Display, inventors Chip Meyers et al, filed Jan. 18, 2012, the entirety of which is incorporated herein by reference.

### BACKGROUND OF THE INVENTION

1. Field of the Invention

The present invention relates generally to managing creative content, typically nonstandard content, for display on a computing device, and more specifically to providing for the auctioning of creative content, such as advertising, for all types of creative content and web site space availabilities.

2. Description of the Related Art

Current internet web site activity entails a user visiting a website. The traditional web site can include fixed zones, areas, or regions employing standards established by a standards board such as the IAB (Interactive Advertising Bureau). In a typical scenario, a web site developer can, for advertising purposes, provide an available region or zone of IAB standard size available on the target web page. The web site developer may provide one or more Javascript tags for the region and may create an aesthetically pleasing web page including the web page with essentially a space or spaces reserved for advertising.

Each advertisement is not necessarily hard coded into the page, nor provided on the same server as the rest of the target page content, but instead may ultimately be provided by a third party when the web site is rendered to the user.

Placement of such content can be marketed by offering the available space in a marketplace and advertising related entities bidding on the available space. For example, depending on user preferences reflected by user cookies or other factors, a user who has visited a number of music sites may at a subsequent site be presented with music advertising content by a third party advertiser. The music seller may pay the third party advertiser who may in turn compensate the web site owner for the use of the space on the web site. Such an arrangement is potentially beneficial for all parties—the user, the web site owner, the advertiser, and the company, i.e. the music seller.

A problem arises when an advertiser or company wishes to provide nonstandard content, or nonstandard ad units (NSAU), on a web site originally set up to display standard content. Nonstandard content may include any type of content, such as static content, overlays, and so forth, having nonstandard or responsive sizing, as well as nonstandard video or other multimedia presentations, and so forth, and may include virtually any graphical representation, size, and/or execution of any type of content that does not satisfy IAB standards. In this nonstandard content situation, content has typically either not been consistently displayable on web sites employing standard IAB regions and Javascript tags, or such content is partially or incompletely displayed. Either situation is unacceptable to both sellers and buyers.

Consistent display and viewability of content is of particular importance. When nonstandard content is provided, the media in the nonstandard content may either be too large to display on the target web site, may interfere with other ad spaces or content of the web site, or may fail to display due to technical restrictions. These conditions are inadequate in the current Internet environment. Also, effectively and efficiently displaying the content on the user screen is particularly challenging when the user may be using any type of device and any type of browser. Various attempts have been made to address these issues, but in large regard these attempts have had varying success. The difficulty is properly providing positioning and rendering nonstandard content dynamically and programmatically, with acceptable viewability for varying creative properties, attributes, and positions without the manual process of adding custom code by the publisher. The result is preferably in a form that is attractive and completely rendered with all desired properties and attributes intact, without omitting content and/or requiring redesign of the target web page or worse, repeated redesign of the target web page depending on the advertising employed. Additionally, the method of programmatic bidding on nonstandard content has been limited. In many instances, limited information about the available space, dimension and technical capabilities is provided to the advertising entity, and typically that information includes standard sized regions provided on the site in question but little if any information about the site's ability to display nonstandard content. Thus the bidder may make and win a bid based on less than adequate information, and as a result the nonstandard content may not be fully displayable on the target web site. A bidder without site properties is simply blindly bidding with his desired nonstandard content with no assurance that the nonstandard content will be accurately displayed. This deficiency is problematic and can result in inefficient bidding, and purchases of advertising space where the advertising cannot be acceptably presented on the intended user device.

While the present discussion has focused on web pages generally, it is to be understood that any device or software that displays nonstandard visual content may have sizing issues and related bidding needing to be addressed. Particularly with recent mobile and tablet innovations, the ability to programmatically, accurately and pleasantly convey content to a user across platforms and devices has never been of more interest.

It would therefore be beneficial to provide a design that accurately and attractively sizes and presents nonstandard content irrespective of the device on which the content is conveyed and allows for accurate bidding on the use of nonstandard content and proper deployment and display of nonstandard content. Such content should be attractively and completely presented, with particular focus on positioning and technical attributes.

### BRIEF DESCRIPTION OF THE DRAWINGS

For a more complete understanding of the present disclosure, reference is now made to the following figures, wherein like reference numbers refer to similar items throughout the figures:

FIG. 1 illustrates a portion of the system including components configured to receive materials or information such as web sites, graphics or multimedia content, and/or requests for providing nonstandard content;

FIG. 2 is a flowchart of the initial intake process;

FIG. 3A shows the formats and positions of target web page elements and elements that may be nonstandard and provided using the present design;

FIG. 3B shows the various actionable positions available,

FIG. 4 represents the deployment portion of the present design;

FIG. 5 shows process flow using SSPs, DSPs, and ad servers;

FIG. 6 is a flowchart of one aspect of deployment of a target web page including nonstandard graphical elements;

FIG. 7 illustrates a site/domain validation process flow;

FIG. 8 is a process flow for auctioning space and deploying content, such as nonstandard graphical content, to a user device; and

FIG. 9 illustrates an out-of-page adaptive ad impression flow chart, including supply, demand, and exchange elements.

The exemplification set out herein illustrates particular embodiments, and such exemplification is not intended to be construed as limiting in any manner.

### DETAILED DESCRIPTION

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

The present design provides a system for universally describing nonstandard ad spaces using positions and attributes to both sellers and buyers of advertising space and providing nonstandard content (including but not limited to graphics, videos and animations) to users, including an automated process of rendering, sizing and deploying such content. In this context, the term “attributes” includes capabilities (hardware, operating system, browser, DOM, etc.), dimensions (viewable area, content width, whitespace or blank space), context (metadata outlining the impressions content context), and intent (search metadata outlining the end user's intent).

In general, when a web site is identified that is to be rendered with nonstandard graphics, the present system obtains all pertinent information from the target page (pre-auction), determines those elements of the target web page that are required, and determines sizes of all other areas available for nonstandard graphics, such as advertising, including left and right side graphics, top graphics, and overlays. Information regarding the available regions is then provided to potential and/or actual bidders who bid on the available space. The winning bidder then provides direction to his content and the present design transmits the complete web page to the user, including the winning bidder's graphical content. The end result is a page including all requisite content plus nonstandard graphics that can subsequently be altered to include different graphics.

Thus the present design includes an ability for the system to evaluate the target page, obtain information regarding available space on the target page, including properties and attributes of the target page (dimensions, zones, areas considered off limits, etc.), convey the information regarding available standard and nonstandard space to potential bidders for that space, and ultimately render the nonstandard content to the user in an attractive format.

As used herein, the following definitions apply. On the demand side, a “user” or “end user” is an entity that provides demand for the system disclosed herein. A “creative” is an advertising unit, typically having a high level of impact and may be standard or nonstandard in size. A “tag” is a third party creative attachment used to render the specified creative, where a “publisher tag” is an attachment used in supplying the creative, and a “creative tag” is a tag employed in accordance with demand for the creative. “Demand statistics” are statistics about the demand for creative, including number of beacon impressions (typically are an indication to request a graphic or skin to be delivered to the web client), overall impressions, and clicks.

On the supply side, a “publisher” is an entity that owns a collection of websites. A “provider” or “content provider” is an entity that supplies content, or a creative, and may bid for space on a site to be viewed by a user A “website” or “site” is a website owned by a publisher that may include placements with or without publisher tags. A “placement” is an ad space placeholder, such as advertising creative content, that resides on a publisher's website and is configured to request advertiser creative from a server or other computing device such as an ad server. “Placement statistics” are statistics about the supply of ad content such as the number of supply side impressions and clicks.

The present design enables the creation and accurate bidding of nonstandard content, such as advertising, on a page such as a target web page or other display. The present design initially detects the width of existing content on a target page, and adds incremental content, such as advertising, to the desired page by determining and utilizing the unused out-of-page (typically blank space provided around page content) space provided, such as on the left or right sides of the page or the top or bottom of the page. Additionally, the present design obtains information about the target page and conveys that information to bidders for space on web sites in a marketplace, and bidders submit bids for and may purchase space, including nonstandard out-of-page content space based on the information provided.

The overall system includes both an ad server and an administrative user interface used to configure the ad server to address both supply of and demand for content. The ad server may be a single device or multiple devices. A database is provided and the ad server and user interface use enable the administrator to use the database directly or through a memory cache in the case of an ad server. The ad server typically includes a collection of modules that may include php scripts that provide Javascript to a web client. The ad server may track beacon impressions, where beacon impressions are an indication for an ad tag request, creative impressions, where creative impressions are an indication that the server provided an indication to draw or render the graphic or skin, and supply side impressions, where supply side impressions are indications that placements provide ad space from publishers. Any type of coding that supports the functionality described herein may be employed.

The present design seeks in part to obtain information, such as HTML or CSS information, from an existing target web page, knowing the nonstandard content desired to be displayed. The present design determines an appropriate layout for all content on the target page including the nonstandard content, and provides the requisite Javascript creative tags and content for full display of the nonstandard content and the target web site on the target web site. The result is basically “two trips” to the target web site; one for determining existing web site structure, followed by processing of target web site attributes for the nonstandard content, followed by a “return trip” to the target web site to deploy or provide the page including the nonstandard content. In this arrangement, the web site may at a later time be changed back to its original form or any other desired form without developer intervention. The entire procedure is adaptive and automated, does not require oversight, approval, rewriting of code, or any significant publisher, advertiser, user or developer intervention.

A further attribute of the present design is a scouting function, wherein the system seeks available information from a web site and provides the discovered information to a marketplace for bidding. In one aspect, the scouting function determines available blank or potential advertising space and positions on a web site, and attributes of the web site such as how the site will be displayed on a user's device, and provides this information (device type, size of available space, standard or nonstandard size, and so forth) to a marketplace wherein bidders may bid based on the information obtained. For example, the scouting function may determine that the target web site is a page having two positions or zones available, one standard and one nonstandard having particular pixel size areas, and may determine that the device being employed is an Apple Mac Air device running Safari. Bidders may have information available, such as the target web site will display 40 percent of the standard graphic region and 80 percent of the nonstandard region, and may wish to bid an amount on the known available space based on the properties and attributes of the page in question, including the positions or zones available. If the bidder is successful, the desired graphical content may be transmitted to the user with a high degree of accuracy and knowledge as to how the graphical information will be rendered. This scouting function thus reduces bidding inefficiencies and improves the ability for a bidder or advertising entity to programmatically purchase and deliver a high impact ad to a desired or potential consumer.

The present design may be implemented on a computing device, such as a server or series of servers. While certain functionality may be described with respect to a single device, it is to be understood that such functionality may be performed using multiple devices. Further, functionality shown on multiple devices may be implemented on a single device.

The present design will be discussed with reference to advertising, but it is to be understood that the functionality and processing disclosed herein is not so limiting. The current state of online advertising is known to those skilled in the art, and includes various components, such as ad servers, exchanges, and so forth, and bidding typically occurs for advertising. Cookies are exchanged between elements to facilitate providing appropriate advertising to specific users. Devices such as Demand Side Platforms (DSPs) and Supply Side Platforms (SSPs) and ad exchanges enable the buying and selling of digital media using real time bidding based on real time information obtained from users.

In normal operation, a user causes his browser to navigate to a web site. The publisher's server provides HTML code, including HTML tags indicating where content is located and formatting for the content. The HTML code may include ad tags, tags representing advertisement which can be obtained from advertising entities and typically change dynamically. The ad tag may point to a real time bidding (RTB) enabled SSP, and may include IAB dimensions, the advertiser's ID and site ID. The SSP typically auctions the advertisement space to one or more DSPs. In addition to a bid, DSPs typically also provide a redirect command, used when the DSP wins the auction. The user's browser then calls the DSP, the DSP provides the redirect, the user's browser calls the advertising entity's ad server, and the advertising entity provides the advertisement to the user's browser.

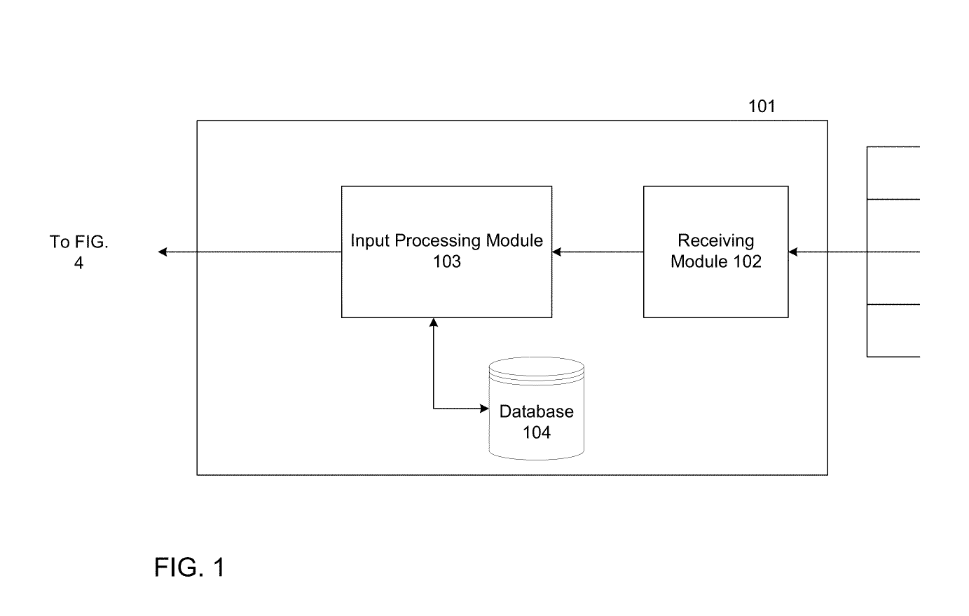

The current discussion takes into account this type of advertising processing, but may be employed in other types of content providing scenarios. FIG. 1 illustrates a general representation of the “intake” portion of the present design. In general, the system 101 is divided into two major functional components—an intake component and a dynamic allocation component. The intake component illustrated in FIG. 1 obtains necessary information and content from a web site owner and/or advertiser, and again may be implemented on a single computing device or multiple computing devices.

In general, the present design may be applicable to multiple campaigns, which typically entail either a content provider or an advertiser seeking to provide nonstandard content to existing or contemplated pages to be viewed by end users. A campaign may include, for example, placing nonstandard content on 1200 web pages, replacing existing standard content on 250 pages with nonstandard content, placing nonstandard content or nonstandard content tags on all web pages associated with a particular URL, or any other operation that provides nonstandard content to web pages as desired by an entity. Standard content may be provided with nonstandard content as desired and as provided within the campaign. A campaign may include a “rotation,” which indicates that certain advertisements or categories of content, such as nonstandard display content, may be displayed on a number of web sites for a period of time.

### Basic Operation

From FIG. 1, system 101 includes a receiving module 102 configured to receive information from external sources (not shown). Receiving may be receipt from web sources, files loaded into system 101, files determined by a user using the system 101 and conveyed to the receiving module, or any other means conventional in the art. Materials or information received may be web sites, graphics or multimedia content, and/or requests for providing nonstandard content to an existing target web page, set of web pages, or URL. Once received, input processing module 103 may process the information received, including determining country restrictions or requirements for the target web page or pages. The input processing module 103 may utilize stored information, where database 104 in FIG. 1 represents any form of storage available, and such storage may be external to system 101. Input processing module 103 may determine rotation requirements, e.g. a web page displayed in country X will include web pages 27 and 28 only, and advertisements G, H, I and J will be offered. Such information may be provided by the entity requesting the campaign or may be determined based on country restrictions and/or information. For example, an advertisement for Icelandic arts and crafts in the Icelandic language may not be desired for a Brazilian URL.

Input processing module 103 may also provide for keyword association, wherein keywords are used to map URLs into categories. Keywords may include words such as “android” “tablet” and “laptop,” which may be mapped into categories such as “Phones” “Mobile” and “Computer,” respectively. Categories are used to match web sites to campaigns. Thus for a web site entitled “androidjunkies.com,” such a site would be categorized as being in the “Phones” category, and “Phone” advertising may be associated with the URL. Keywords may also be associated with URLs but not in the name of the URL.

Subsequent to employing keywords to map URLs into categories, the input processing module 103 classifies URLs entered via receiving module 102. URLs classified are then mapped into rotations by the processing module 103. For example, if an advertisement for mobile phones is to be deployed in a rotation of advertisements, a URL classified as “Mobile” may receive such an advertisement or set of content. A default category may be provided that the input processing module 103 employs for any uncategorized URL. If a URL includes multiple categories, the processing module combines all sets of nonstandard content.

The system then matches content to URLs based on rules and associations provided for the campaign and determined for the specific URL and specific content. The net result is an advertisement or set of nonstandard content to be provided with a target web page or web pages in a URL.

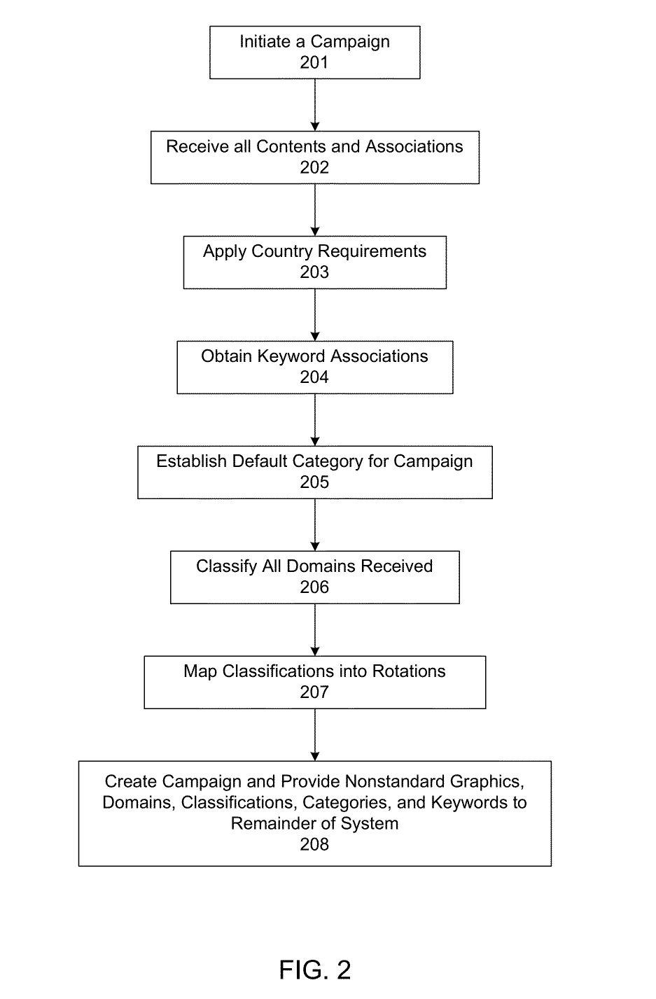

FIG. 2 shows this initial process. Element 201 initiates a campaign, namely providing associations between sets of content, potentially including nonstandard content, and sets of URLs and/or target sites. Element 202 receives and determines all content and associations, and element 203 applies country requirements. Element 204 determines keyword associations, wherein keywords map URLs into categories. Element 205 establishes a default category for the campaign, while element 206 classifies all URLs based on the categories available. The system 101 takes the classifications in element 207 and maps the classifications into rotations. Point 208 creates the campaign and provides content, including nonstandard content, URLs, classifications, categories and keywords to the remainder of the system 101.

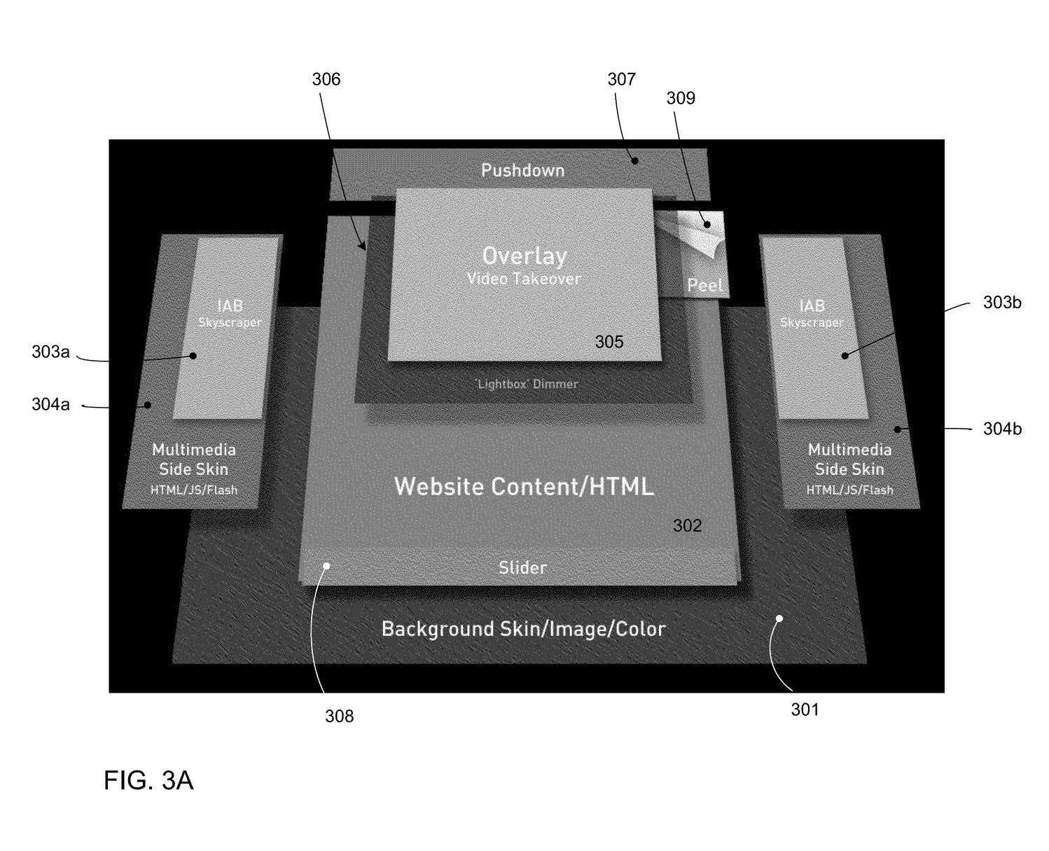

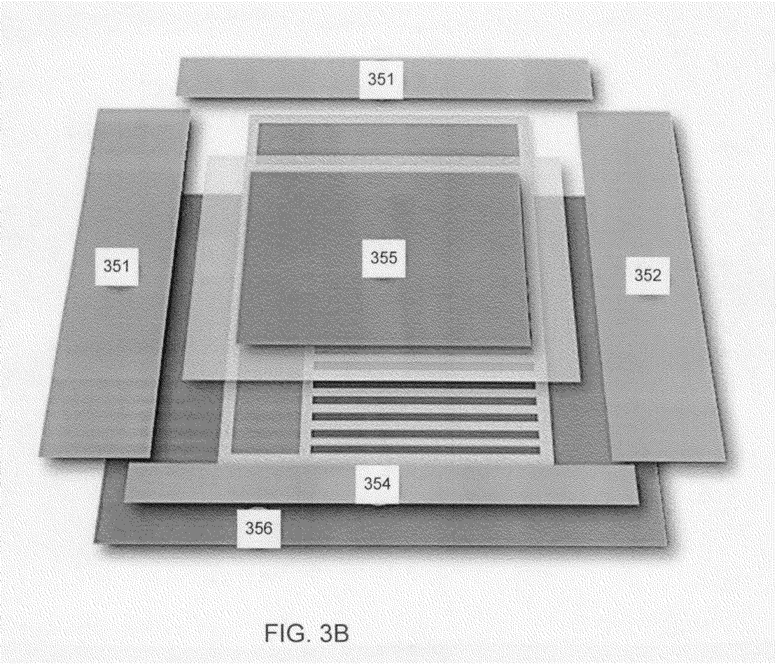

FIG. 3A illustrates the various formats and general positions for nonstandard content in a target page. From FIG. 3A, a background 301 may be provided, with web site content 302 provided over the background 301. The IAB mandates dimensions for a “skyscraper” 303, with two such skyscrapers 303a and 303b illustrated. Beneath each skyscraper 303a and 303b is a multimedia side skin 304a and 304b, each of which may include HTML, Javascript, Adobe Flash elements, or other content, wither nonstandard or standard. A video takeover 305 may be provided that essentially “takes over” the screen, including a “lightbox” dimmer 306 that enables clear viewing of the video takeover 305. Also provided are pushdown region 307, slider region 308, and a possible peel region 309 used with either overlay 305 or lightbox dimmer 306. All formats (background, side elements, top and bottom elements, video takeover, etc.) can be used alone or in combination with the other formats. Also, in place of or in addition to a video takeover, a top graphic may be provided, standard or nonstandard.

The zones or regions shown in FIG. 3A are general and are generally adhered to by web designers. However, the present design may employ an “out of page” adaptive ad format for virtually any type of creative content and display thereof on a given web page. The “out of page” adaptive format is sizeless and does not occupy a fixed area or dimensions. The format of the creative/ad is evaluated by the system and specified for each impression based on supply properties (positions, i.e. available creative/ad positions based on page content and attributes, with attributes including environment, context, and intent) and demand properties, such as demand positions (creative/ad positions based on creative type and attributes, with attributes including behaviors and technical attributes such as media types). On the demand side, the content can cause movement of the creative or the content where appropriate, such as expanding a top, bottom, or side portion to push page content aside, expanding part of the creative over or into the page content, and overlaying the page.

General actionable positions available to web designers are illustrated in FIG. 3B. From FIG. 3B, position 351 is referred to as the left space, representing a left “gutter” space between page content and the browser edge or screen edge. Position 352 is referred to as the right space, representing a right “gutter” space between the page content and the browser edge or screen edge. Position 353 is the top space, positioned above the content and able to expand, i.e. push downward. Position 504 is the bottom space, representing the bottom of the browser or screen and may represent a region covering page content. Position 505 is the over space, floating over the page content, frequently partially transparent. Position 506 is the under space, representing graphics or a region behind page content. Actionable positions depend on impression properties as well as seller restrictions.

Under normal circumstances, i.e. for providing standard IAB content, for each existing IAB skyscraper creative element that is to be applied to at least one target site, the input processing module 103 reads the URL (Uniform Resource Locator, known to be a character string representing a reference to an internet resource (web page, file, etc.)) for the iFrame (inline frame, used to embed another document in the HTML of the page) that contains the existing IAB skyscraper creative element. The input processing module 103 writes out the Javascript tag of the value for the SKYSCRAPER_IFRAME variable along with other required values related to the IAB skyscraper creative element (position, etc.). The input processing module 103 then adds the Javascript tag with the URL for the IAB skyscraper creative element to a server or other device associated with the advertising entity. The advertising entity may then provide the content mandated by the Javascript tags and the advertising entity may then deploy the Javascript tag through a server, such as an advertising server, to a publisher, where the publisher publishes the web site to the user. When the user visits the web page, she receives the target page including the IAB creative element or elements, and Javascript in operation displays the IAB creative element on the appropriate position on the user's screen. This represents the automated process of deploying standard content to the user.

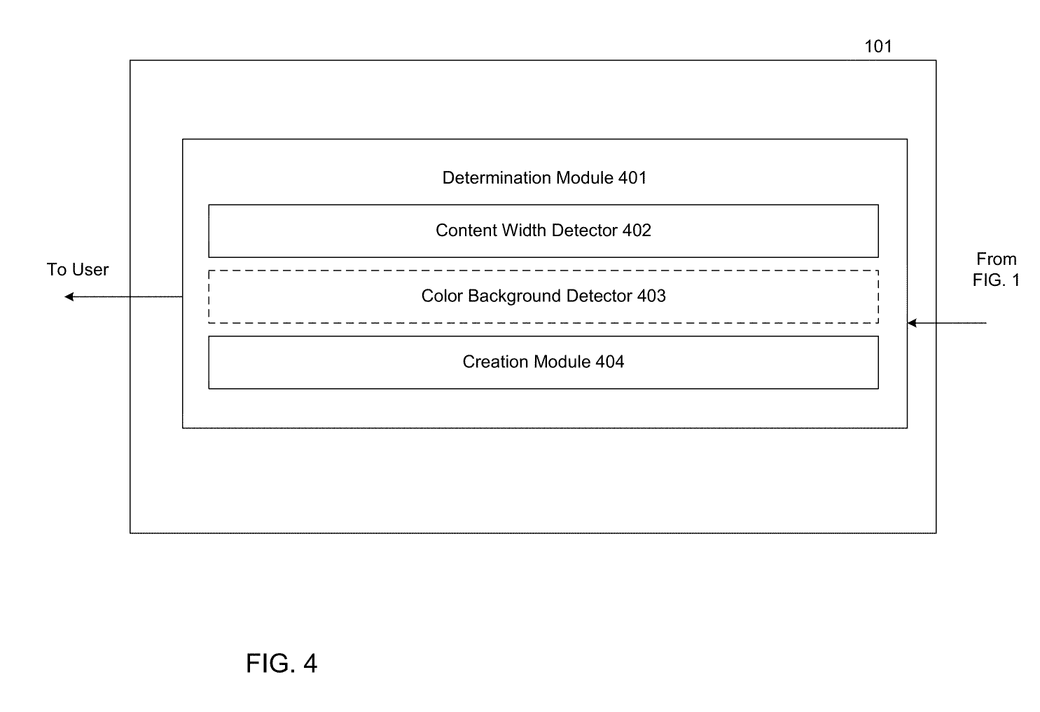

FIG. 4 illustrates the deployment components of the system 101, where the system seeks to deploy nonstandard creative elements to the user. In general, determination module 401 creates nonstandard zones in target pages where existing standard zones are employed or where such nonstandard components logically fit. The determination module 401 then dynamically creates/provides for nonstandard zones or regions by modifying the end user's document object model (DOM). Determination module 401 includes content width detector 402 and color background detector 403. Content width detector 402 sets a default width, such as 1000 pixels. The content width detector 402 script is configured to detect the width of the selected URL. The content width detector 402 iteratively assesses all divs (HTML div tag, used to define a division in an HTML document) in the body of the HTML of the window. The content width detector determines the width of each div and stores the maximum width. If the divs did not have a width specified, the width is set to a default value. The content width detector then employs the width obtained. In this manner, the width of various elements on a page may be detected and standardized such that content may be inserted or altered while maintaining a desired look and feel of a site or target page.

The present design and the content width detector 402 use the extra space on the sides of the page content to display nonstandard graphics. The space visible to the end user depends on the end user's screen resolution. The actual screen resolution minus page content size defines a safe area, the safe area representing space safely viewable by the end user. Standard web site content is typically on the order of 1000 pixels currently, while screen resolutions can vary and may include, for example, 1280 pixels of viewable space or higher, and in most instances resolutions of 1280×768 may be required. The 280 pixel edges of the safe area may be employed to add creative elements, while the entire safe area will still include all essential copy. For higher resolutions, additional area may be available, but such area can be used for nonessential or secondary imagery to enhance the user experience, but may not be available to all users. Thus content width detector determines the space available for the desired content based on known resolutions.

Color background detector 403 is generally optional in that it may or may not be employed, and when employed, obtains the creative element and loads the file, in an appropriate format such as png, gif, or jpg, into a php library (not shown). A php library is known in the art to be a preprocessing library for HTML pages. The color background detector 403 obtains the color for a certain number of pixels proximate the left side of the creative element, such as the colors in a line a certain number of pixels from the left edge of the creative element. The colors obtained are stored by the color background detector 403 in an array. The color background detector 403 may then obtain pixels proximate the right side of the creative image, such as the colors in a line a certain number of pixels from the right edge of the creative element, and this line of colors added to the array. Left and right may be processed in any order, and the number of pixels from the edge may vary, and more than one line may be sampled and added to the array. The color background detector then samples the array to determine the dominant color from the color array and uses this color as the background color for the creative element.

Color background detector 403 may use the color array to collect all colors for selected pixels and determine a single, uniform background color for the graphic based on all colors in the array. Alternately, background colors may be determined for each graphic, i.e. one graphic sampled and the background color for that graphic determined, and another graphic sampled and background color determined for that graphic. Such an implementation can be useful if multiple background colors may be employed.

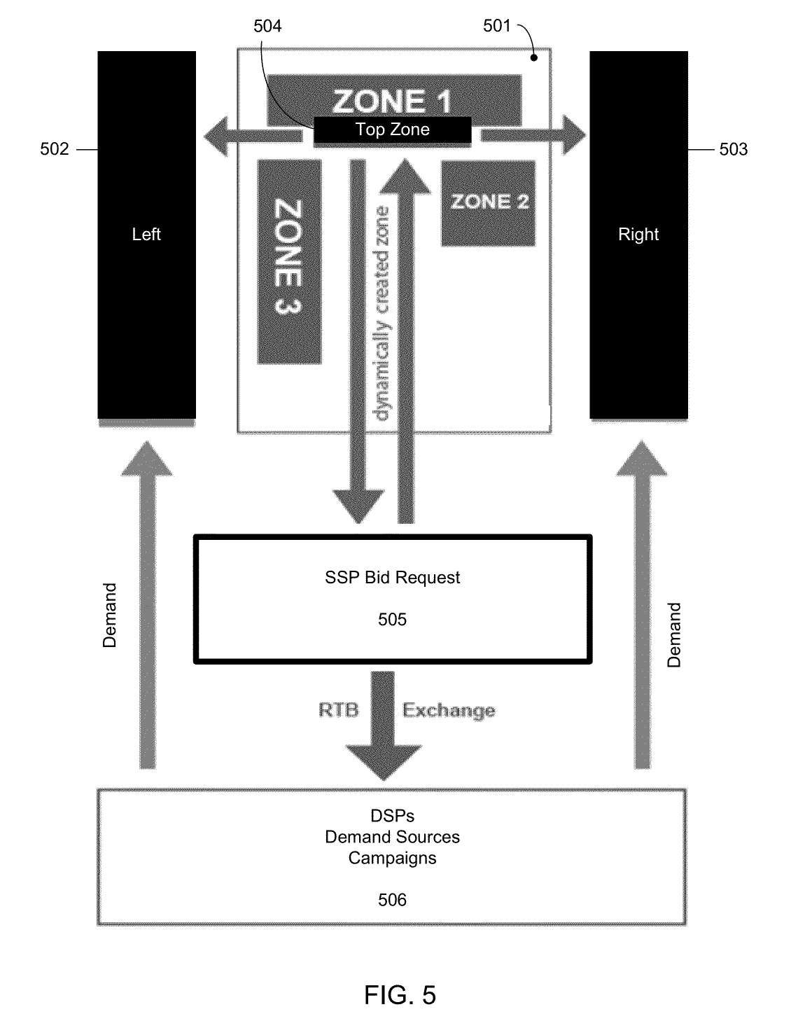

Size and content processing occurs in the context of the operations illustrated in FIG. 5. FIG. 5 generally reflects the SSP/DSP/ad server scenario described above, with general zones provided. As described below, zones or regions wherein creative content may be displayed differ and can be altered to a number of nonstandard forms, and the zones and regions of FIG. 5 are provided as a general baseline. FIG. 5 generally illustrates dividing the existing page into regions, identifying available regions, and providing for bidding on available regions as part of a campaign. From FIG. 5, the publisher may have provided a target page having zones 1, 2, and 3 in target page 501. Additional content may be provided based on the available free space determined by content width detector 402, shown as content zones 502 and 503. A further IAB standard content zone 504 may have been provided by the site publisher. Point 505 represents an SSP bid request. Point 506 represents DSPs bidding on the cookie using the real time bidding exchange. When a bid is accepted, and the user requests loading of a page that points to a nonstandard element, the user's browser is directed to the nonstandard content and the web site. At this point, content processing using creation module 404 occurs.

Typical creative content provided may include a left graphic that may be displayed in left content zone 502, a right graphic that may be displayed in right content zone 503, and a central graphic or video or multimedia graphic in the center of the target page or at or near IAB standard content zone 504. In the case of a left graphic, creation module 404 creates a div element, namely “lwrap div”, which serves as the container for the left graphic. The creation module then sets a depth index to locate the left graphic on top of any existing background and sets the height of the left graphic to be at the top of the page and any overflow, i.e. excess graphic, to be hidden. The creation module 404 sets the left position of the lwrap to be at zero pixels (0 px) from the left side of the display, and the right edge to 50 percent to cause the lwrap div to span the left half of the viewable page. The creation module 404 then appends the lwrap div to the body of the HTML page.

The creation module 404 then creates the left skyscraper div, which will contain the left side HTML content. The creation module 404 sets the width of the left skyscraper div to the specified width of the left side HTML content, sets height to 100 percent, and sets the left skyscraper div to an absolute position, with visibility set to “visible.” The creation module 404 sets the background color to the color determined by color background detector 403. The creation module then sets the right position of the left skyscraper div to zero to position the div, and sets some left padding to spread the background color to the left. Some number of pixels may be employed as padding, such as 1000 pixels to the left, but other values may be employed. The creation module 404 then sets the inner HTML for the left div content to the inner HTML for the left side of the graphic. Creation module 404 then appends the left skyscraper div to the lwrap div and adds the result to the target page.

The creation module 404 then provides for the right side graphic. Creation module 404 creates a div element, namely “rwrap div”, which serves as the container for the right graphic. The creation module then sets the depth index to locate the right graphic on top of any existing background and sets the height of the right graphic to be at the top of the page and any graphic overflow to be hidden. The creation module 404 sets the right position of the rwrap to be at zero pixels (0 px), and the left edge to 50 percent to cause the rwrap div to span the right half of the viewable page. The creation module 404 then appends the rwrap div to the body of the HTML page.

The creation module 404 then creates the right skyscraper div to contain the right side HTML content. The creation module 404 sets the width of the right skyscraper div to the specified width of the right side HTML content, and sets the right skyscraper div to 100 percent height and sets the right skyscraper div to an absolute position, with visibility set to “visible.” The creation module 404 then sets the background color to the color determined by color background detector 403. The creation module 404 sets the left position of the right skyscraper div to zero to position the div, and provides some right padding to spread the background color to the right. Some number of pixels may be employed as padding, such as 1000 pixels to the right, but other values may be employed. The creation module 404 then sets the inner HTML for the right side DIV content to the inner HTML for the right side of the graphic. Creation module 404 then appends the right skyscraper div to the rwrap div and adds the result to the target page.

Similarly, creation module 404 may add a top section to the target page. The top graphic may be any type of graphic, including multimedia, in which case the following may apply to positioning of the lightbox dimmer or the multimedia graphic. Creation module 404 creates a twrap div, which serves as the container for the top graphic. The creation module 404 then sets the depth index to locate the top graphic above any existing background, i.e. to be viewable such that the background is not viewable. Creation module 404 sets the top of the top graphic to a zero point (0 px), the left of the top graphic to be zero (0 px) the width to be 100 percent of available width, and the height to the specified height of the top section. The creation module 404 sets any graphic overflow to be hidden and background color to the background color determined by color background detector 403. The creation module 404 then appends twrap div to the body of the HTML page, before the first child element on the body of the target page.

The creation module 404 then creates the new top div to contain the top HTML content. The creation module 404 sets the width and height of the top div to the specified width and height of the top HTML content, and also sets the right margin to zero (0 px) and the left margin to the negative value of the width of the top div divided by two. The creation module 404 then sets the background color for the top div to the background color determined by color background detector 403 and sets the left position of the top div to 50 percent, i.e. the midpoint of the target page. The creation module 404 then sets the HTML of the top div to be the specified HTML for the top section, and appends the top div to the twrap div to add the top content to the page.

As may be appreciated, the ordering of processing by the creation module may be altered from the foregoing, such as when, for example, no left skyscraper is desired, or by processing the top div content before either side, or processing right before left.

The resultant target web page, including nonstandard graphics, is provided to the user. As an option, the system may retain previous attributes such that the target web page may revert to its initial form or some previous form. Alternately, the system may use the procedures disclosed herein to change the page to display IAB standard graphics, with simple adjustments to positions and attributes in accordance with the foregoing.

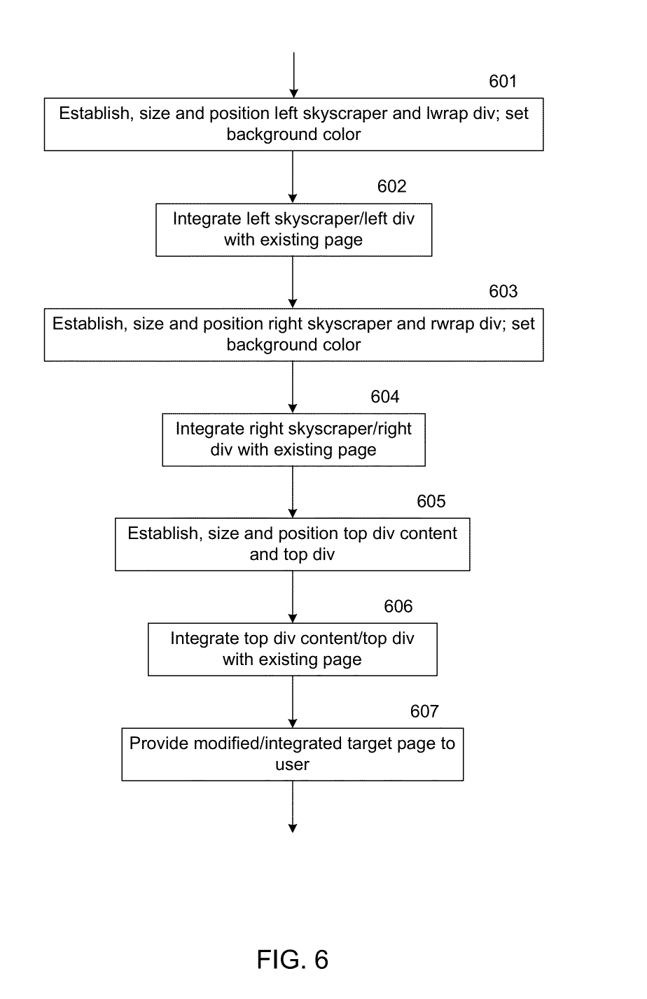

Operation of creation module 404 may be as shown in FIG. 6. Upon initially being contacted with a target web site that requires nonstandard graphics, the creation module 404 has the particulars of the web site or may obtain the particulars of the web site as discussed above if not available. The creation module 404 then establishes and sizes both the left skyscraper and left wrap div (lwrap div), and may optionally set background color at point 601. The right skyscraper is integrated into or combined into the target page at point 602. The creation module establishes and sizes the right skyscraper and right wrap div (rwrap div) at point 603, and may optionally set background color. The right skyscraper is integrated into or combined into the target page, including the right skyscraper, at point 604. Once integrated, these skyscrapers are available with the required content for the target web site. Point 605 sets the top div content and top div, including any lightbox dimmer, sizing and positioning the top div appropriately, which again are nonstandard. Point 606 calls for adding the top div to the page. At point 607, the complete page, including nonstandard graphics, is provided to the user.

### Enhanced Operation—Scouting Function and Bidding

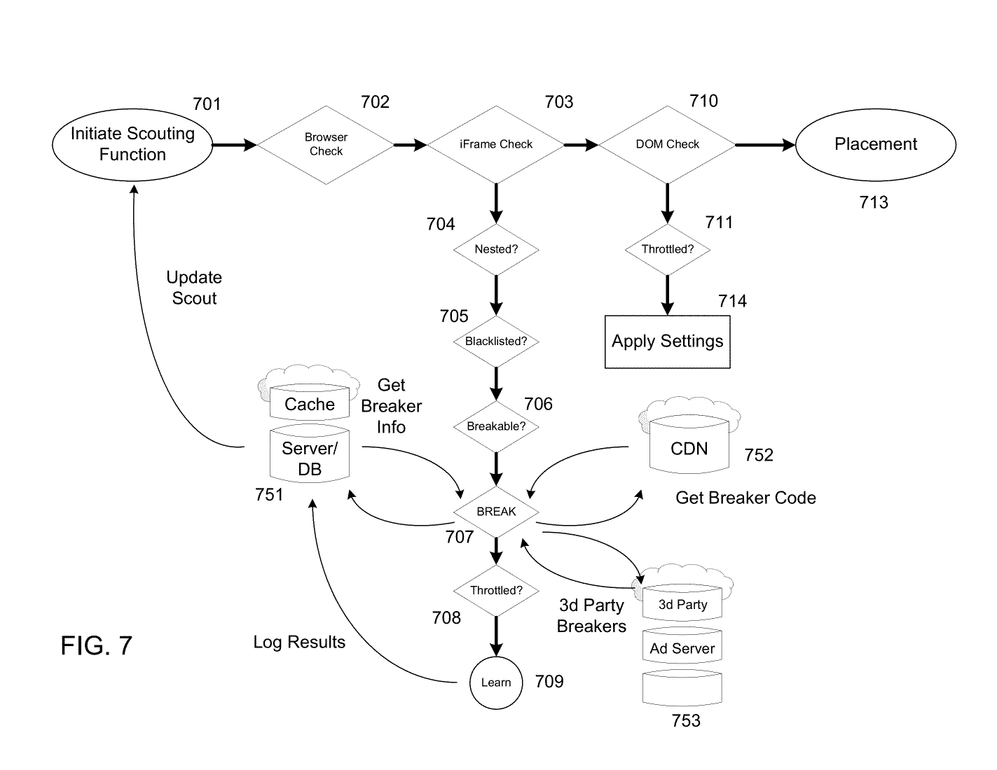

The system may include a scouting function and may enable bidding on assets based on information obtained using the scouting function. FIG. 7 illustrates an overview of the scouting function validation processing. In essence, the design of FIG. 7 seeks to investigate domains and set the domains for placement of content, including ignoring sites that will not accept or are not configured to receive content for one reason or another, establishing settings for the domain/site, and reporting information found regarding the domain back to a server or server arrangement.

From FIG. 7, the scouting function is initiated at point 701 whereupon scout functionality, such as a scout Javascript, is sent from a content delivery network (CDN) to a web page. Point 702 checks the agent/browser support and the screen width for the device being employed. Point 703 performs an iFrame check, where an iFrame designation is HTML code used to insert content from another source, such as an advertisement, into a Web page. The system performs an iFrame check to determine if an iFrame is present and the parameters of the iFrame. Certain iFrame parameters can present problems for the goal of displaying content on a page, including nested browsing contexts, blacklisted web pages or URLs, or breakable web pages. Nested browsing contexts represent pages inside of pages, and use of nested browsing contexts is typically undesirable. Point 704 evaluates for nested browsing contexts and if present does not retrieve information about the domain or yields an indication that the domain is not conducive to advertising using a typical rendering of a single instance of graphical content. Point 705 determines if the domain is on a permanent blacklist and if so the system does not retrieve the domain or alternately provides an indication that the domain is not conducive to the desired form of advertising. Point 706 evaluates whether iFrame breakers are present on the domain, and if the iFrame is breakable. An iFrame breaker is code enabling DOM (Document Object Model) access to the iFrame's parent element, necessary to display content. If an iFrame breaker is not present, the system again does not retrieve or otherwise process the domain when iFrames are detected.

Point 707 seeks to “break” out of an iFrame to gain access to the DOM of the domain or web site. Point 707 proceeds to break the web site, obtaining breaker logic from a remote location such as a server or server arrangement 751. The specific breaker code, such as breaker Javascript, may be obtained from CDN 752, and the system may validate the breaker file using third party information at third party server arrangement 753. The system may then break the iFrame, enabling code to be placed within available space on the particular web page on the domain being scouted.

Point 708 performs throttling, wherein throttling is an ability to control, set and limit the number of scouted impressions. Point 709 “learns” about the domain in question, including providing domain information to server or server arrangement 751 and updating any scout functionality, i.e. changing code to reflect appropriate treatment of the site or other similar sites. The system keeps track of only those locations where an evaluation has previously been performed. In other words, the “learning” performed evaluates whether the site/domain has been scouted previously, and if so, the scouting process at the site ceases, unless there is an indication the site has changed since last evaluated. In order to not excessively slow down system operation, the learning function may reduce the amount of scouting that is performed, the amount of updates due to new sites, and the amount of information that is provided to server or server arrangement 751. This “learning” reduces the amount of data and information tracked.

At domain check 710, the system validates the domain, wherein validating the domain includes a highly detailed examination of the domain, including but not limited to access to the DOM, finding of centerlines, evaluating the DOC declaration for the type of HTML pages on the domain, body width, and other details pertinent to the various pages available on the domain. Point 711 checks impression throttling, evaluating whether the system has set the domain to be throttled or whether the information regarding the domain should for any reason not be obtained. Point 712 applies the settings for the domain, including fixed width settings, header offset(s), and floor. The settings applied are the desired settings for the site, including HTML code to accommodate standard and nonstandard graphics.

The foregoing scouting function thus investigates domains and rules out domains wherein content cannot be displayed. If content can be displayed, the site is altered to accommodate the desired graphical content, and entire domains can be investigated for content distribution and set up to accept content. In one example, a non-throttled domain may have a front page that has no regions that can accept graphical content, i.e. the site displays content from side to side and top to bottom. Sub-pages, however, may include usable space as determined by the scout, and the particulars of the site provided to server or server arrangement 751 and settings applied to the domain to enable display of content in acceptable regions of the sub-pages. Point 713 indicates placement of the graphic.

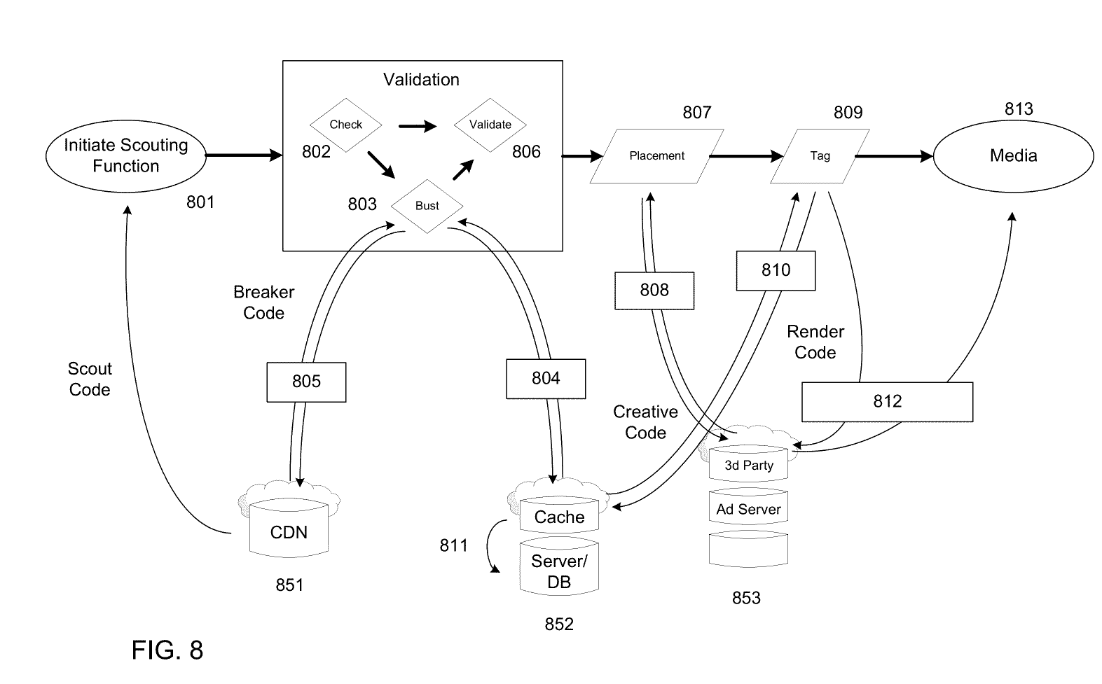

FIG. 8 illustrates the process flow for scouting. At point 801, the scout function is initiated, such as by CDN 851. At point 802, the scouting function begins to validate the site/domain in question as shown in FIG. 7, checking the user agent/browser support and screen width to evaluate the availability of space on the page. At point 803, the system determines whether the scout code is placed inside an iFrame. Point 804 causes the functionality to request iFrame logic from server or server arrangement 852, which may include a cache and a database. The server or server arrangement 852 provides iFrame logic, and at point 805 the scouting function seeks iFrame breaker code from CDN 851. The scouting function then breaks the iFrame, enabling code, such as HTML code or Javascript, for example, to be provided on the page in question. Point 806 validates the domain, including validating domain and site attributes such as doc declaration, center div, body width, and so forth.

At this point, the particulars of the site are available and may be provided to, for example, CDN 851 or server or server arrangement 852. These devices may interface with an exchange server, also called an ad server, shown as ad server 853, for the express purpose of auctioning or inviting bidding on the known domain space. As an example, information regarding the target or subject domain may be available, including available standard and nonstandard space, pages where content may be displayable, position of the graphic, device being employed, browser being employed, and any other available and relevant information. This information is provided to third party ad server 853. Point 807 thus writes out an ad server placement tag to third party ad server or server arrangement 853. Point 808 indicates initiation of an auction for the available space on the subject site. Third party ad server 853 then returns the winning bid, indicating the party winning, and either explicitly or impliedly the ad or graphical content to be served or rendered on the subject site.

Point 809 represents providing the creative content to the subject web page, accomplished by retrieving the creative content from server or server arrangement 852 as shown in point 810. At point 811, the server or server arrangement 852 logs the impression data into the database indicating the ad is being provided to the target site. Such logging of impression data evidences the attempt to render the creative content as well as the identity of the creative content, time rendered, and other information potentially useful to future bidders and/or administrators of the system. Point 312 indicates the system transmits a request for media files from the third party ad server 853, and at point 813, the system renders and displays all desired creative content in the space in the page on the domain, including standard and nonstandard content.

To facilitate the scouting, bidding, and rendering functionality, the present system may employ a new media type on the third party ad server 853, which may be any type of server arrangement or appropriate platform. The media type may be custom and may be sized to identify the media type and/or positions or attributes associated with the media type, such as an indication the size is one by one, the media type is a “skin,” the media sub-type is IAB (Interactive Advertising Bureau standard) and the media sub-type is “custom,” having attributes of iPad 4, Safari 6.04 (capabilities), viewable area of X by Y pixels, content of 0.75× pixels, whitespace of 15 percent left side and 10 percent right side (dimensions), with certain context and intent values. In this instance, the system creates a third party one by one tag or placement for the new media type and sub-types. The system then integrates the third party tag, used for out-of-page media types, into a custom adaptive tag. The adaptive tag performs pre-auction impression checks and dynamically writes the third party tag on valid or viewable impressions. The adaptive tag may be pushed to the publisher using an existing tag to avoid manual installation of additional tags.

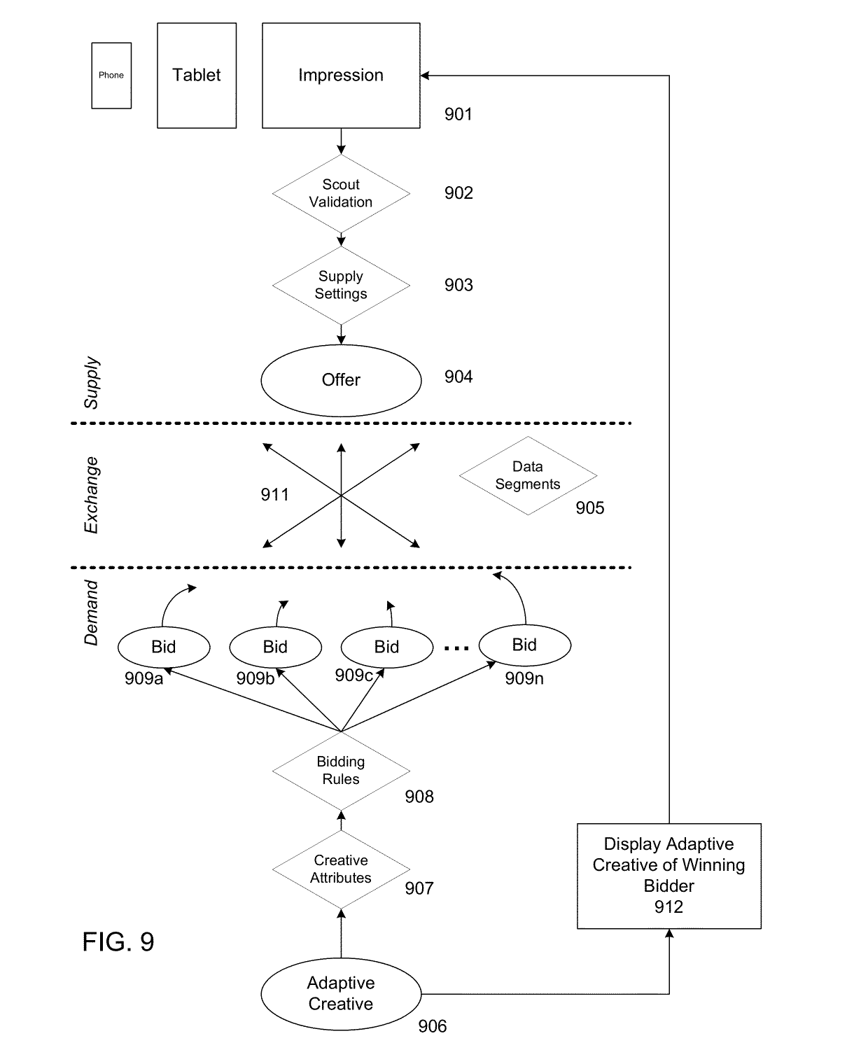

FIG. 9 illustrates a general flow diagram for out-of-page adaptive ad impressions. From FIG. 9, three processes are provided, supply, exchange, and demand. Impression 901, on the supply side, is validated by the scouting function at point 902, including validation of capabilities, positions, and dimensions. Supply settings 903 define rules and base prices for the impression, including positions, attributes, geographic restrictions, and frequency of the impression based on results from the scouting function 902. These values are provided in an offer 904, the offer including the available capabilities, positions, dimensions, attributes, geography, frequency and reserve price of the available space. Element 905 indicates exchange specific metadata is added to the offer and an auction is opened.

On the demand side, at point 906, an adaptive creative is provided and can be served at any position, i.e. the creative is not restricted. The creative may be given attributes or restrictions at point 907, such as dimensions, expected position on a page (e.g. side, top/bottom, overlay, standard size region). At point 908, the bidding requirements are established, and between point 908 and the bid 909, the bid may be adjusted based on impression capabilities, positions, dimensions, and metadata associated with the available space as determined on the supply side, i.e. at point 903. Points 909a-n indicate multiple bids may be provided on the known available space, with full knowledge by the bidders of the attributes and capabilities of the available space, standard or nonstandard, and at exchange 910, the highest bidder wins the auction. Point 911 indicates the adaptive creative of the highest bidder is provided as the impression and displayed to the end user.

Thus the present system provides a method for obtaining information for each impression about a domain and websites associated with the domain, wherein the information includes standard and nonstandard graphical areas, and using the information in a bidding process by providing bidders with the standard and nonstandard space available on the site and enabling bidders to bid on this basis. The winning bidder has graphical content deployed on the web site in a known arrangement, thus providing bidding efficiencies and visually attractive end results.

The present design includes a method and apparatus for providing graphic content to a user device. The method includes evaluating a target web site and if the target web site is configured to receive content, altering code on the target web site, storing target web site information, providing target web site information, including information about at least one nonstandard region, to at least one bidder, facilitating an auction of the at least one nonstandard region to the at least one bidder, and establishing a winning bidder and displaying graphical content associated with the winning bidder in the one nonstandard region on the target web site on the user device. These functions may be provided using a server arrangement.

Alternately, the present design includes a method for providing graphic content to a user's computing device, including obtaining information about available display zones from a domain using a server arrangement, wherein the available display zones comprise standard sized zones and nonstandard sized zones, providing the information about the available display zones including the standard sized zones and nonstandard sized zones to at least one bidder using the server arrangement, auctioning space on the available display zones including the standard sized zones and nonstandard sized zones to at least one bidder and awarding a right to display on the space on at least one available display zone to a highest bidder using the server arrangement, and rendering creative content associated with the highest bidder in at least one display zone on the user's computing device.

The present design may be implemented using a network or distributed system, including a single server or multiple servers, and functionality may be distributed over multiple components or may exist in a single component. Further, functionality described herein may operate in hardware, software, firmware, or any combination thereof and no description provided herein is intended to be limiting in this regard. The present design may be substantially or completely internet based, operating with one or more servers, such that the user can access a server to request information, such as reports, as well as surveys, campaigns, resources, and other information. Users may modify the systems database contents from a platform providing, for example, Internet browsing capabilities.

While primarily described herein with respect to a knowledge management system, the invention and disclosure herein are not intended to be so limited. While certain examples are provided herein, these examples are meant to be illustrative and also not limiting as to the functionality of the present system. For example, while certain functions are suggested to be performed by a single individual, multiple persons may perform those functions. Other examples and implementations are possible and this document should not be limited by the examples presented. Other examples of knowledge resource allocation may be realized using the current design.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A method for providing graphic content to a user's computing device, comprising:
obtaining information about available display zones from a domain using a server arrangement, wherein the available display zones comprise standard sized zones and nonstandard sized zones;
providing the information about the available display zones including the standard sized zones and nonstandard sized zones to at least one bidder using the server arrangement;
auctioning space on the available display zones including the standard sized zones and nonstandard sized zones to at least one bidder and awarding a right to display on the space on at least one available display zone to a highest bidder using the server arrangement; and
rendering creative content associated with the highest bidder in at least one display zone on the user's computing device.

2. The method of claim 1, wherein a plurality of bidders bid on the space.

3. The method of claim 1, wherein obtaining information about available display zones comprises:
determining attributes of an existing page from code associated with the existing page; and
identifying display zones based on mandatory content on the existing page and existing page attributes.

4. The method of claim 3, further comprising determining whether additional creative content cannot be displayed on at least a portion of the existing page, and if additional creative content cannot be displayed, ceasing determining attributes and identifying display zones.

5. The method of claim 3, further comprising altering code for the existing page to enable creative content display on the existing page.

6. The method of claim 1, further comprising, after said auctioning, obtaining creative content associated with the winning bidder from a remote server arrangement.

7. The method of claim 1, further comprising storing information about available display zones from the domain in a database for future reference.

8. The method of claim 7, further comprising updating information about available display zones from the domain in the database when the information has changed.

9. A computing device configured to provide graphic content to a user device, comprising:
means for obtaining information about available display zones from a domain, wherein the available display zones comprise standard sized zones and nonstandard sized zones;
means for providing the information about the available display zones including the standard sized zones and nonstandard sized zones to at least one bidder;
means for auctioning space on the available display zones including the standard sized zones and nonstandard zones to at least one bidder and awarding a right to display on the space on at least one available display zone to a highest bidder; and
means for rendering creative content associated with the highest bidder in at least one display zone on the user's computing device.

10. The apparatus of claim 9, wherein a plurality of bidders bid on the space.

11. The apparatus of claim 9, wherein the means for obtaining information about available display zones comprises:
means for determining attributes of an existing page from code associated with the existing page; and
means for identifying display zones based on mandatory content on the existing page and existing page attributes.

12. The apparatus of claim 11, further comprising means for determining whether additional creative content cannot be displayed on at least a portion of the domain, and if additional creative content cannot be displayed in the space, ceasing determining attributes and identifying display zones.

13. The apparatus of claim 11, further comprising means for altering code for the existing page to enable creative content display on the existing page.

14. The apparatus of claim 9, further comprising means for obtaining creative content associated with the winning bidder from a remote server arrangement.

15. The apparatus of claim 9, further comprising means for storing information about available display zones from the domain in a database for future reference.

16. The apparatus of claim 15, further comprising means for updating information about available display zones from the domain in the database when the information has changed.

17. A method for providing graphic content to a user device, comprising:
evaluating a target web site and if the target web site is configured to receive content, altering code on the target web site;
storing target web site information;
providing target web site information, including information about at least one nonstandard region, to at least one bidder;
facilitating an auction of the at least one nonstandard region to the at least one bidder; and
establishing a winning bidder and displaying graphical content associated with the winning bidder in the one nonstandard region on the target web site on the user device;
wherein said evaluating, storing, providing, facilitating, and establishing are performed by a server arrangement.

18. The method of claim 17, wherein evaluating the target web site comprises:
determining attributes of the target web site from code associated with the target web site; and
identifying display zones based on mandatory content on the target web site and target site attributes.

19. The method of claim 18, further comprising determining whether additional creative content cannot be displayed on at least a portion of the target page, and if additional creative content cannot be displayed, ceasing determining attributes and identifying display zones.

20. The method of claim 18, further comprising altering code for the target page to enable creative content display on the target page.
